(19) United States
(12) Patent Application Publication
(10) Pub. No.: US 2026/0026647 A1
(43) Pub. Date: Jan. 29, 2026

(54) GRAIN COOKING APPLIANCE

(71) Applicant: WHIRLPOOL CORPORATION, BENTON HARBOR, MI (US)

(72) Inventors: MELISA PADILLA ESPINOZA, ST. JOSEPH, MI (US); JOY K. KEMPIC, STEVENSVILLE, MI (US); LAUREN NELSON, ST. JOSEPH, MI (US); ERIC D. SNYDER, GRAND RAPIDS, MI (US)

(21) Appl. No.: 18/787,181

(22) Filed: Jul. 29, 2024

(51) Int. Cl. A47J 36/32; A47J 27/10

(52) U.S. Cl. CPC A47J 36/321; A47J 27/10

(57) ABSTRACT

A grain cooking appliance can include a cooking chamber for cooking an amount of grain within a liquid. The grain cooking appliance includes a liquid dispenser fluidly coupled to the cooking chamber to provide liquid to the cooking chamber. A user interface is provided on the grain cooking appliance to permit a user to interact with the grain cooking appliance. A controller is configured to store a grain to liquid ratio, determine a volume of a liquid that meets the grain to liquid ratio based an amount of grain in the cooking chamber, and dispense the volume of the liquid to the cooking chamber from the liquid dispenser.

### TECHNICAL FIELD

The description generally relates to a household food preparation appliance and, in particular, a household food preparation appliance for preparing a grain.

### BACKGROUND

Household cooking appliances can be used to prepare food for consumption or used to prepare food for later cooking preparation. Grains are typically provided within a liquid and heated to boil or cook the grains for consumption or other use.

### BRIEF DESCRIPTION

In one aspect, the disclosure relates to a grain cooking appliance comprising: a cooking chamber; a liquid dispenser fluidly coupled to the cooking chamber; a controller operably coupled to the liquid dispenser, the controller configured to: store a grain to liquid ratio; determine a volume of a liquid that meets the grain to liquid ratio based upon an amount of grain in the cooking chamber; and dispense the volume of the liquid to the cooking chamber from the liquid dispenser.

In another aspect, the disclosure relates to a grain cooking appliance comprising: a cooking chamber; a controller configured to: determine an amount of grain within the cooking chamber; determine a volume of liquid within the cooking chamber; determine a grain to liquid ratio based upon the amount of grain and the volume of liquid within the cooking chamber; and store the grain to liquid ratio.

### BRIEF DESCRIPTION OF THE DRAWINGS

In the drawings:

FIG. 1 is a perspective view of a grain cooking appliance having a cooking chamber, a fluid reservoir, and a user interface, in accordance with an aspect of the disclosure.

FIG. 2 is a schematic view of the user interface of FIG. 1, showing a main menu including a selection for custom cycles for cooking a grain, in accordance with an aspect of the disclosure.

FIG. 3 is a schematic view of the user interface of FIG. 1, showing a custom cycles menu after selection of custom cycles at FIG. 2, including a custom rice cycle, in accordance with an aspect of the disclosure.

FIG. 4 is a schematic view of the user interface of FIG. 1, showing a custom rice menu after selection of the custom rice cycle of FIG. 3 for creating the custom rice cycle by selecting add custom rice, in accordance with an aspect of the disclosure.

FIG. 5 is a schematic view of the user interface of FIG. 1 after selection of add custom rice at FIG. 4, showing instructions to a user for adding a rice or grain to the cooking chamber, in accordance with an aspect of the disclosure.

FIG. 6 is a schematic view of the user interface of FIG. 1 after adding of rice to the cooking chamber, showing a measured weight of the rice or grain within the cooking chamber, in accordance with an aspect of the disclosure.

FIG. 7 is a schematic view of the user interface of FIG. 1, including selections for preparation, liquid type, and texture for the custom rice cycle, in accordance with an aspect of the disclosure.

FIG. 8 is a schematic view of the user interface of FIG. 1, showing instructions to add a volume of liquid to the cooking chamber and having a next function, in accordance with an aspect of the disclosure.

FIG. 9 is a schematic view of the user interface of FIG. 1, showing an input or measured volume of liquid for the added volume of liquid to the cooking chamber after selecting the next function of FIG. 8, and having a start function, in accordance with an aspect of the disclosure.

FIG. 10 is a schematic view of the user interface of FIG. 1, showing a cooking timer after starting of the custom grain cooking cycle after selecting the start function at FIG. 9, displaying an estimated cooking time for cooking the rice at the custom rice cooking cycle, in accordance with an aspect of the disclosure.

FIG. 11 is a schematic view of the user interface of FIG. 1, showing a cooking timer with an estimated time remaining for completion of the custom rice cycle and a keep warm function, in accordance with an aspect of the disclosure.

FIG. 12 is a schematic view of the user interface of FIG. 1, showing a cooking done indication, a keep warm time after selection of the keep warm function of FIG. 11, in accordance with an aspect of the disclosure.

FIG. 13 is a schematic view of the user interface of FIG. 1, showing a request to save the custom rice cooking cycle after a user selects the close function of FIG. 12 having a no function and a yes function, in accordance with an aspect of the disclosure.

FIG. 14 is a schematic view of the user interface of FIG. 1, showing that the keep warm function has completed after a user selects the keep warm function of FIG. 11 or 12, and includes a confirmation function, in accordance with an aspect of the disclosure.

FIG. 15 is a schematic view of the user interface of FIG. 1, showing a request to save the custom grain cooking cycle after the user selects the yes function of FIG. 13 or the confirmation function of FIG. 14, in accordance with an aspect of the disclosure.

FIG. 16 is a schematic view of the user interface of FIG. 1, showing a confirmation that the custom grain cooking cycle has been completed and including a go to custom cycles function, in accordance with an aspect of the disclosure.

FIG. 17 is a flow chart showing a method of cooking a grain in a cooking chamber, in accordance with an aspect of the disclosure.

### DETAILED DESCRIPTION

Traditional preparation of grains follow a preparation with a predetermined amount of grain and a predetermined amount of liquid. The liquid and grain are added by a user to a cooking chamber, like a pot, and heated to cook the grain in the liquid. However, it can be desirable to vary the recipe preparation of the grain, such as to prepare more or less of the grain or liquid, or to prepare the grain in a particular way or manner that varies from the recipe preparation. It is desirable to permit a user to save such a preparation within a cooking appliance for repeated preparation at a later time, without requiring the user to otherwise remember the particular preparation or weigh an exact amount of grain to achieve the same preparation. Additionally, it may be desirable for the household food processing device to have a user interface in which the preparation of the grain can be entered and saved for later use.

Features, advantages, and aspects of the present disclosure are set forth or apparent from a consideration of the following detailed description, drawings, and claims. Moreover, the following detailed description is exemplary and intended to provide explanation without limiting the scope of the disclosure as claimed.

All directional references (e.g., top, bottom, vertical, horizontal, etc.) are only used for identification purposes to aid the reader's understanding of the present disclosure, and do not create limitations, particularly as to the position, orientation, or use of aspects of the disclosure described herein. Connection references (e.g., attached, coupled, fastened, and connected) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, the terms “a,” “an,” and “the” include plural references unless the context clearly dictates otherwise. As used herein, the term “set” or a “set” of elements can be any non-zero number of elements, including only one.

As used herein, the term “grain” refers to any type of grain, which is cooked and softened by heating in a liquid, including but not limited to rice, beans, lentils, wheat, barley, oats, rye, corn, amaranth, buckwheat, chia, or quinoa. A grain can be a caryopsis fruit traditionally harvested for consumption and can include: cereals including but not limited to millet, spelt, or wild rice; pulses including but not limited to chickpeas, peas, and soybeans; or oilseeds, mustards, asters, flax seeds, hemp seeds, poppy seeds, or ancient grains.

The exemplary drawings are for purposes of illustration only and the dimensions, positions, order and relative sizes reflected in the drawings attached hereto can vary.

Additionally, as used herein, a “controller” can include a component configured or adapted to provide instruction, control, operation, or any form of communication for operable components to affect the operation thereof. A controller can include any known processor, microcontroller, or logic device, including, but not limited to: Field Programmable Gate Arrays (FPGA), an Application Specific Integrated circuit (ASIC), a Proportional controller (P), a Proportional Integral controller (PI), a Proportional Derivative controller (PD), a Proportional Integral Derivative controller (PID controller), a hardware-accelerated logic controller (e.g. for encoding, decoding, transcoding, etc.), the like, or a combination thereof. Non-limiting examples of a controller can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a processor or controller module can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to affect a functional or operable outcome, as described herein. In another non-limiting example, a control module can include comparing a first value with a second value and operating or controlling operations of additional components based on the satisfying of that comparison. For example, when a sensed, measured, or provided value is compared with another value, including a stored or predetermined value, the satisfaction of that comparison can result in actions, functions, or operations controllable by the controller module. As used herein, the term “satisfies” or “satisfaction” of the comparison is used herein to mean that the first value satisfies the second value, such as being equal to or less than the second value or being within a predetermined value range of the second value. It will be understood that such a determination may easily be altered to be satisfied by a positive/negative comparison or a true/false comparison. Example comparisons can include comparing a sensed or measured value to a threshold value or threshold value range.

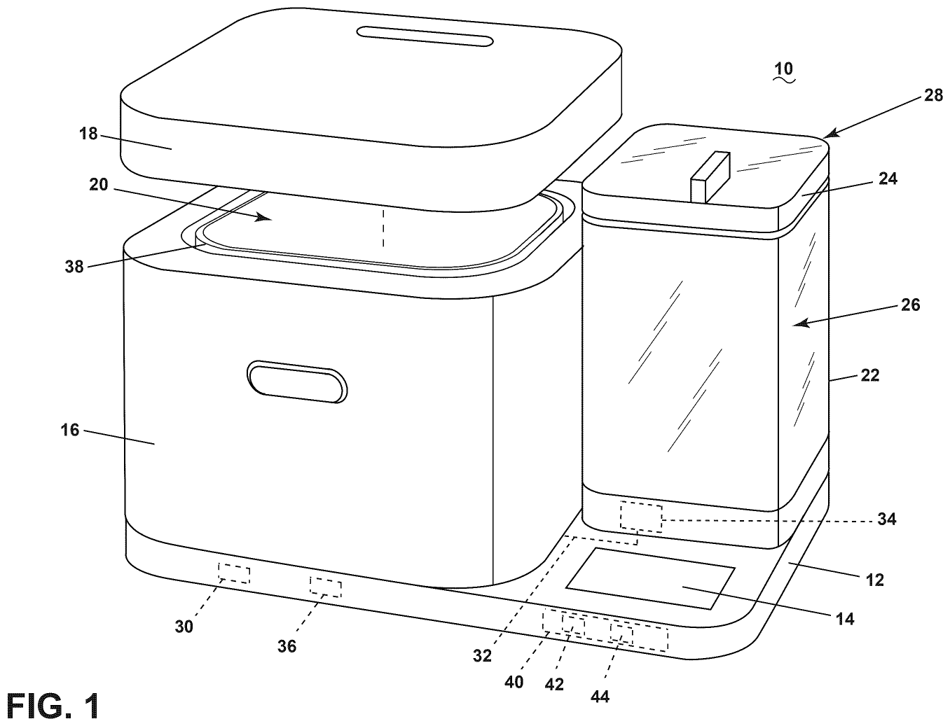

FIG. 1 illustrates a grain cooking appliance 10 having a base 12 with a user interface 14. The user interface 14 can be a touch screen display, for example, while any display providing communication to a user, permitting user input to the grain cooking appliance 10, or both is contemplated. A basin 16 extends from the base 12 and includes a basin lid 18 that may be removed to access a cooking pot 38 defining a cooking chamber 20. The cooking pot 38 can position within the basin 16 at a received position, while the cooking pot 38 may further be lifted away from the basin 16 to a lifted position (not shown) wherein the cooking pot 38 is not fully received within the basin 16. A reservoir 22 couples to the base 12 and includes a reservoir lid 24 for accessing a reservoir interior 26, such as for filling the reservoir 22 with liquid, like water. It is further contemplated that the reservoir 22 can be removable from the base 12.

A conduit 32 can fluidly couple the reservoir 22 to the cooking chamber 20 through the base 12, the basin 16, and the cooking pot 38. A pump 34 can be fluidly coupled to the conduit 32 in order to pump a volume of liquid from the reservoir 22 to the cooking chamber 20. In this way, the reservoir 22 can be a liquid dispenser 28 for dispensing a volume of liquid to the cooking chamber 20 via the conduit 32 and the pump 34. A heater 36 can be provided in the base 12 and adjacent the basin 16 and the cooking pot 38 to heat the cooking chamber 20. Alternately, it is contemplated that the heater 36 can be provided in the cooking pot 38 and operatively coupled to the base 12 at the basin 16. Further still, it will be understood that the reservoir 22 may be directly fluidly coupled to the cooking chamber 20 without passing through the base 12 or the basin 16. In such an example, appropriate sealing mechanisms and metering devices can be included.

A weight sensor 30 can be provided in the base 12 or the basin 16 to measure a weight of the cooking pot 38, a weight of food or items within the cooking chamber 20, or a combination thereof. Further still, the weight sensor 30 can be utilized to determine whether the cooking pot 38 is attached to the basin 16 (like at the received position) or has been removed from the basin 16 (like at the lifted position). In a non-limiting example, a separate sensor (not shown) from the weight sensor 30 can be utilized to determine if the cooking pot 38 is attached to the base 12 or basin 16 in order to determine if the cooking pot 38 is in the received position or has been removed from the basin 16. Regardless of whether one or more sensors are utilized, the sensor(s) can be operably coupled to a controller 40.

The controller 40 can be provided in the base 12 and can include a processor 42 and a memory 44. The controller 40 can be operably coupled with one or more components of the grain cooking appliance 10 for communicating with and controlling the operation of the grain cooking appliance 10 to complete a cycle of operation. In non-limiting examples, the controller 40 can operably couple with the user interface 14, the weight sensor 30, any additional sensor(s) (not shown), the pump 34, the heater 36, the processor 42, and the memory 44 to control the operation of these and the grain cooking appliance 10 to implement one or more of the automatic cycles of operation. In a further non-limiting example, the controller 40 can couple with the weight sensor 30 to receive input relating to the weight of the cooking pot 38, the weight of a material within the cooking chamber 20, or indication that the cooking pot 38 is positioned in the basin 16, has been removed, or has been returned to the base 12. In yet another non-limiting example, the controller 40 can be communicatively and operably coupled to the heater 36 to control operation thereof. Control of the heater 36 can be used to execute one or more cycles of operation including heating a grain and liquid within the cooking chamber 20 to cook the grain, or to determine a temperature of the cooking chamber 20. Furthermore, the heater 36 can provide feedback related to energy use in order to determine a temperature of the cooking chamber 20.

It is contemplated that the controller 40 is a microprocessor-based controller that implements control software and sends/receives one or more electrical signals to/from each of the various working components to effect the control software. As an example, proportional control (P), proportional integral control (PI), and proportional derivative control (PD), or a combination thereof, a proportional integral derivative control (PID control), can be used to control the various components. The controller 40 can include a number of electronic components commonly associated with electronic units utilized in the control of electromechanical systems. For example, the controller 40 need not be limited to the processor 42 and the memory 44, and can include additional electronic components, such as an analog interface circuit (not shown) or PCB (not shown). The controller 40 and the processor 42 may be any type of device capable of executing software or firmware, such as a microcontroller, microprocessor, digital signal processor, or the like. For example, it is contemplated that the controller 40 and the processor 42 can be a microprocessor-based controller that implements control software and sends/receives one or more electrical signals to/from each of the various working components to effect control software.

The memory 44 can be used for storing the control software that is executed by the controller 40 in completing the cycle of operation using the grain cooking appliance 10 and any additional software. The memory 44 can be embodied as one or more non-transitory, machine-readable media. The memory 44 can be configured to store, among other things, instructions in the form of, for example, a software routine (or routines) which, when executed by the processor 42, allows the controller 40 to control operation of the grain cooking appliance 10. The memory 44 can be used for storing the control software that is executed by the controller 40 in performing a selected operation to be executed by the grain cooking appliance 10 and any additional software. For example, the memory 44 can store a set of executable instructions including at least one user-selectable operation. The memory 44 can also be used to store information, such as a database or table, and to store data received from one or more components of the grain cooking appliance 10 that can be communicably coupled with the controller 40. The database or table can be used to store the various operating parameters for the one or more cycles of operation, including factory or default values for the operating parameters and any adjustments to them by the controller 40 or by user interface 14. For example, in non-limiting aspects, the memory 44 can store the determined values measured by the weight sensor 30 or provided during use of the heater 36.

It will be understood that the user interface 14 can receive data from the controller 40, indicative of information to be displayed on the user interface 14. The user interface 14 can include any suitable communication technology including that of a liquid crystal display (LCD), a light-emitting diode (LED) array, or any suitable display that can convey a message to the user. Additionally, the user interface 14 can be a touchscreen display to receive input from the user at the user interface 14. In an alternative, non-limiting example, dedicated buttons (not shown) can be utilized to receive input from the user at the user interface 14. In this manner, the user interface 14 can provide data and input to the controller 40.

Other communications paths and methods, with or without the user interface 14, can also be included in the grain cooking appliance 10 to allow the controller 40 to communicate with the user in a variety of ways. For example, the controller 40 can be configured to send a text message to the user, send an electronic mail to the user, or provide audio information to the user either through the grain cooking appliance 10 or utilizing another device such as a mobile phone. In a non-limiting example, the user interface 14 can be used by a user to manually toggle (e.g., ON/OFF) power to the grain cooking appliance 10. For example, the user interface 14 can be used by a user to manually select the cycle of operation or settings related thereto. For example, a user can provide instructions to the controller 40 via the user interface 14. In non-limiting aspects, information indicated or provided at the user interface 14 can be saved to the memory 44.

In operation, an amount or weight of grain and an amount or volume of liquid can be added to the cooking chamber 20. Non-limiting examples of liquids include water, stock, or broth. The heater 36 heats the cooking chamber 20 to cook the grain in the liquid for a predetermined time according to a cycle of operation. Once cooking has completed, the cooked grain can be removed from the cooking chamber 20 or can be heated and stored in the cooking chamber 20 for later use.

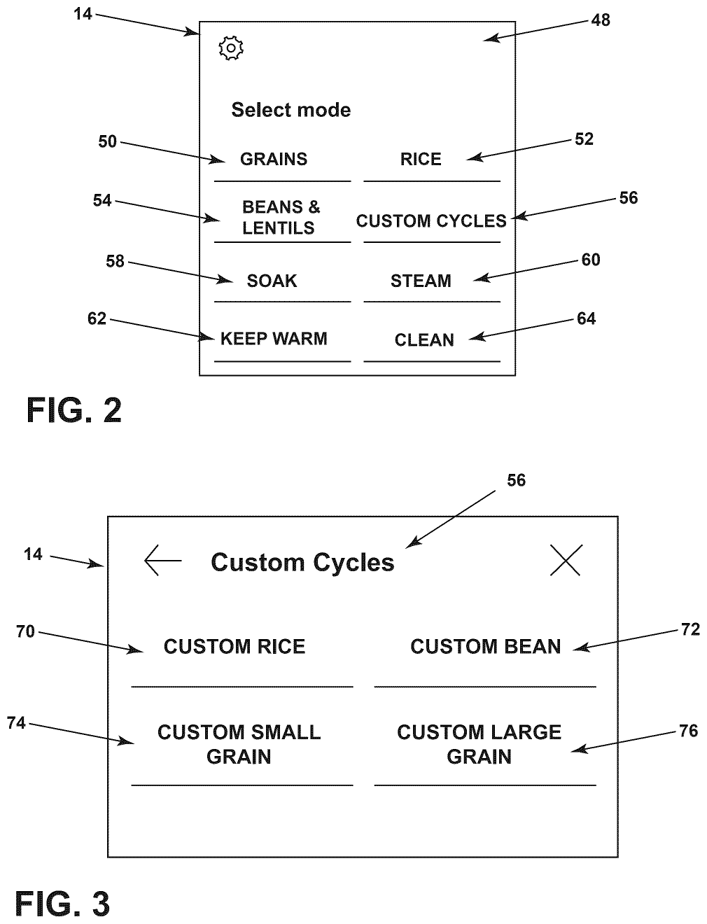

FIG. 2 shows the user interface 14 at an exemplary main menu 48 with different selectable modes which correlate to different cycles of operation capable of completion by the grain cooking appliance 10 (FIG. 1). It will be understood that the user interface 14 can include one or more controls permitting the user to operate the grain cooking appliance 10 according to a cycle of operation. The modes can be cooking modes specific to a type of grain, shown as a grains mode 50, a rice mode 52, or a beans and lentils mode 54, or can be a custom cycle 56. A custom cycle 56 is a cycle created by the user with unique requirements for cooking a grain according to a cycle of operation. Additional modes can include, in non-limiting examples, a soak mode 58 for soaking the grain, a steam mode 60 for steam cooking the grain, a keep warm mode 62 for warming a cooked grain, and a clean mode 64 for running a cleaning cycle. A user can select the custom cycle 56 for creating a custom grain cooking cycle.

FIG. 3 shows the user interface 14 after selection of the option for the custom cycle 56 of FIG. 2. In this manner it will be understood that the user interface provides dynamic output depending on input received from a user. Further still for specific options such as the custom cycle further options are linked and then presented to the user. In this instance, the selection of the custom cycle 56 can present a list of different types of grain cooking cycles, including a custom rice cycle 70, a custom bean cycle 72, a custom small grain cycle 74, and a custom large grain cycle 76 in non-limiting examples. While the description herein is discussed with reference to rice, additional custom cycles 56 can be specific to any type of grain or can permit the user to select the type of grain from a list of grains stored in the controller 40 (FIG. 1) and output to the user interface 14, and the use of rice herein is exemplary. In this manner it will be understood by selecting one of the options within FIG. 3 another set of linked input options will be displayed on the user interface 14 depending on what option is selected.

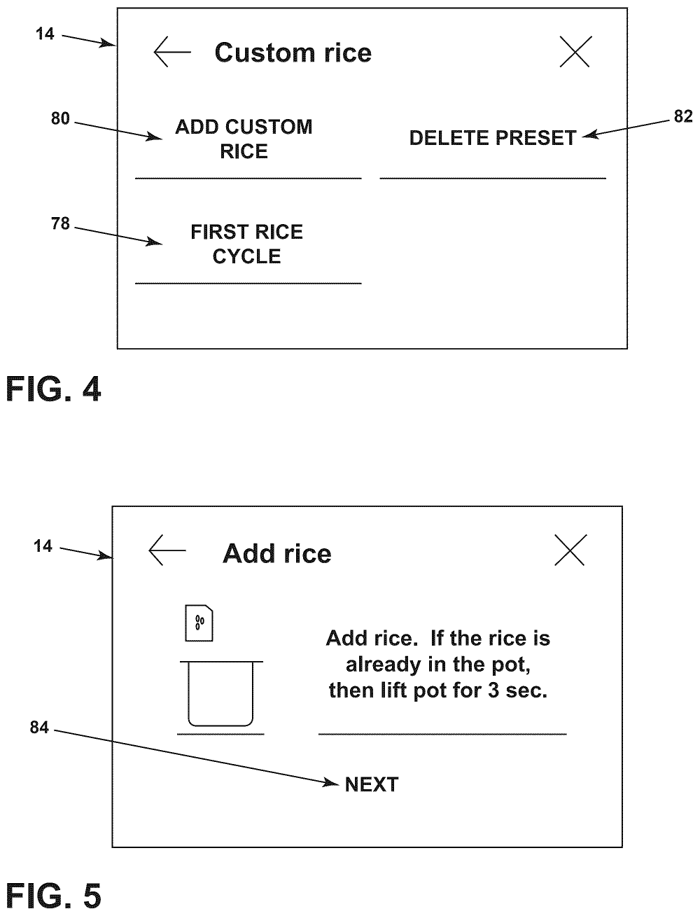

FIG. 4 shows the user interface 14 after selection of the custom rice cycle 70 of FIG. 3 with options for custom rice cycles. A user can select to add a new custom rice cycle by selecting add custom rice 80. Alternatively, a user can select delete preset 82 permitting a user to delete a stored custom cycle linked to the previous selection of the custom rice cycle 70 of FIG. 3. A stored custom rice cycles, shown as a first rice cycle 78, can also be listed here as an option. It will be understood that multiple custom cycles may be included as linked options for a specific grain or more specifically for the previous selection of the custom rice cycle 70 of FIG. 3

FIG. 5 shows the user interface 14 after selection of add custom rice 80 at FIG. 4. The user interface 14 directs the user to add the rice to the cooking chamber 20 (FIG. 1), unless the rice has already been added to the cooking chamber 20, in which case the user interface 14 alternatively directs the user to lift the cooking pot 38 from the basin 16 for three seconds and then return the cooking pot 38 to the basin 16 to the grain cooking appliance 10 to indicate grain within the grain cooking appliance 10 (FIG. 1). Optionally, a next function 84 can be selected by a user to proceed with rice already in the cooking chamber 20. In non-limiting examples, adding the rice to the cooking chamber 20 or lifting the cooking pot 38 (FIG. 1) can be recognized by the weight sensor 30 as a change in weight and can then direct the controller 40 (FIG. 1) to measure the weight of the rice based upon such a change in weight. Alternatively, an additional sensor can be utilized to determine the lifting of the cooking pot 38 and then the weight sensor may be utilized.

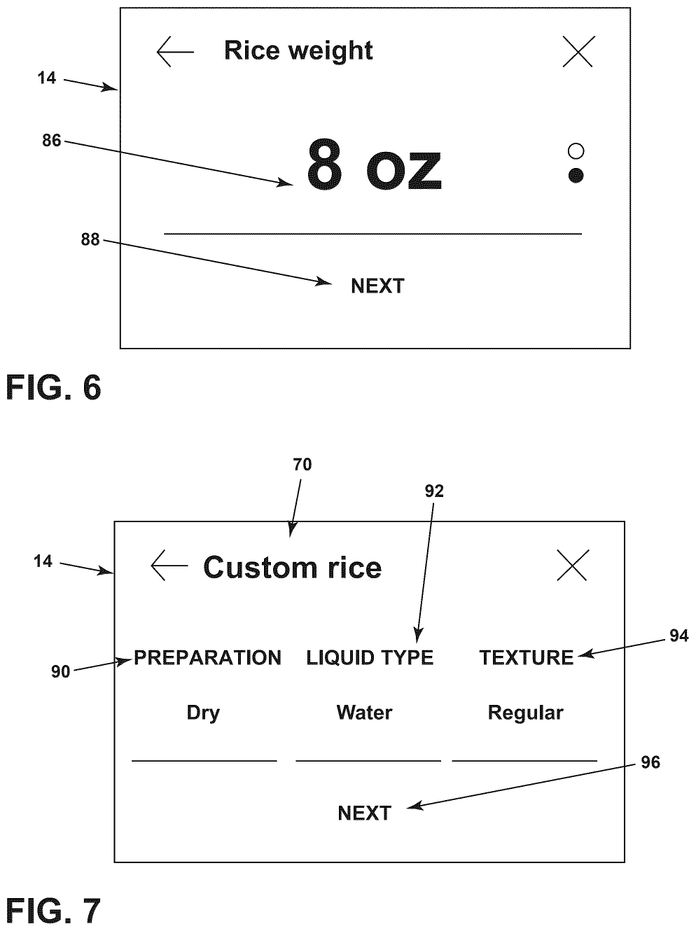

FIG. 6 shows the user interface 14 displaying the measured weight of the grain 86. More specifically, a change in weight of the cooking chamber 20 as a result of addition of the rice can be used to determine the weight of the rice by subtracting the weight of the cooking pot 38 (FIG. 1) from the measured total weight of the cooking pot 38 carrying the rice, as the weight of the cooking pot 38 is known and can be stored in the memory 44. The user can select the next function 88 to confirm the weight of the grain. Additionally, the user interface 14 can permit the user to enter or change the weight of the grain. It is further contemplated that the user can enter a volume of grain, and the controller 40 can determine the weight of the grain based upon the volume and known weight of the grain per unit volume, which can be stored on the memory 44 of the controller 40. A next function 88 permits the user to confirm the weight of the grain at the user interface 14. Alternatively, the grain cooking appliance may omit this display.

FIG. 7 shows the user interface 14 with additional options for the custom rice cycle 70 after the user confirms the weight of the grain at FIG. 6 by selecting the next function 88. The additional options displayed can include, in non-limiting examples, a preparation of the grain 90, a liquid type 92, and a texture 94. Preparation of the grain 90 can include, in non-limiting examples, dry, wet, or washed, where a dry preparation utilizes a dry grain, a wet preparation uses a wetted grain, and a washed preparation utilizes a grain that has been washed. Such a preparation can vary the amount of liquid contained in the grain prior to addition of the liquid used to cook the grain. Therefore, the preparation can vary the resultant cooked grain based upon the amount of liquid utilized in the preparation, and a user may wish to vary the amount of liquid added based upon the preparation. Such a preparation can be stored as part of the custom grain cycle.

The liquid type 92, in non-limiting examples, can include linked options of water, stock, or broth, which can be selected depending on the type of liquid used to cook the grain. Texture 94 can relate to the intended texture of the cooked grain. In non-limiting examples, the linked options for texture 94 can be regular, sticky, soft, firm, or al dente. Cooking times, temperatures, or liquid content can determine the texture of the cooked grain, and selection of the texture can vary the cooking time or temperature of the cycle of operation in order to achieve the desired texture. After the user has selected the preparation of the grain 90, the liquid type 92, and the texture 94, the user can select the next function 96 to confirm the preparation selections for the custom grain cycle. The user can select a next function 96 to proceed with the cycle of operation. It is contemplated that actuation of the inputs for preparation of the grain 90, liquid type 92, or texture 94 can cycle through selectable options for the respective input. Illumination of one or more indicators can indicate the currently selected option or the option may simply remain on the display. Additionally or alternatively, other visual or audible indicators, such as buzzing or blinking, are contemplated in communicating the user selectable options to the user. Additionally, other communication is contemplated, such as haptic feedback or remote messaging in non-limiting examples.

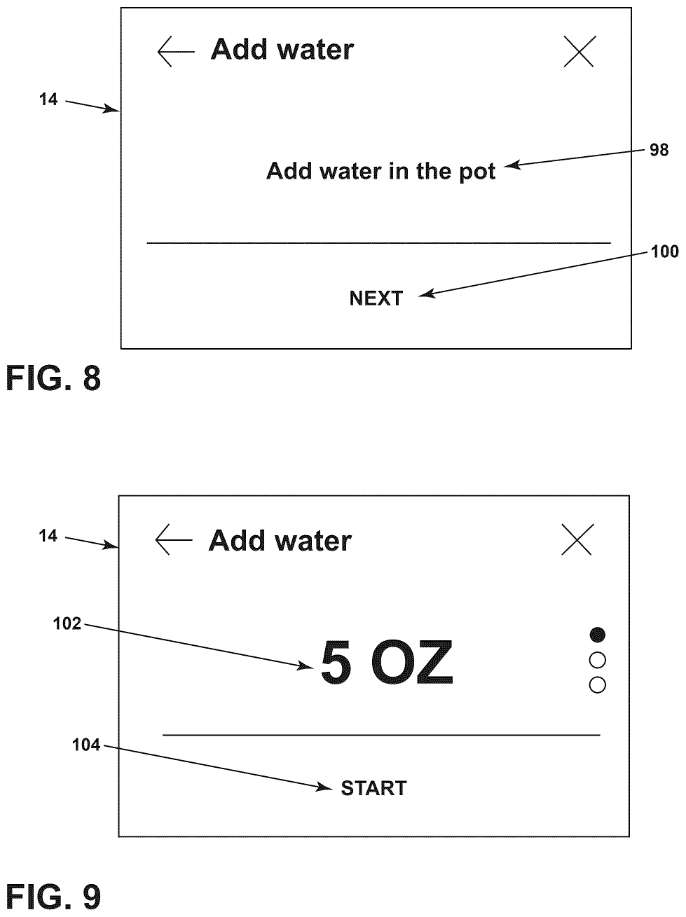

FIG. 8 shows the user interface 14 after selection of the next function 96 of FIG. 7, displaying a request 98 for the user to add liquid to the cooking chamber 20 (FIG. 1). In a non-limiting example, the user can remove the basin lid 18 (FIG. 1) and manually add a predetermined amount of liquid. The weight sensor 30 (FIG. 1) can measure the weight of the cooking pot 38 to determine that liquid has been added to the cooking chamber 20 (FIG. 1) based upon the change in weight. After the user has added the liquid to the cooking chamber 20, the user can select the next function 100 to confirm liquid has been added to the cooking chamber 20.

FIG. 9 shows the user interface 14 displaying a volume of liquid 102 added to the cooking chamber 20 after pressing the next function 100 of FIG. 8. In a non-limiting example, the weight sensor 30 (FIG. 1) can determine a weight of the added liquid, and then the controller 40 (FIG. 1) can determine a volume of the liquid based upon the weight of the added liquid and the liquid type 92 entered at FIG. 7. Each liquid type can have a predetermined density that can be stored on the memory 44 (FIG. 1). The controller 40 can determine the volume of liquid added to the cooking chamber 20 based upon the measured weight and the stored density in order to automatically determine the volume of liquid added to the cooking chamber 20. After entering or confirmation of the volume of liquid, the user can press the start function 104 to initiate the custom grain cycle to begin cooking the grain in the liquid within the cooking chamber 20.

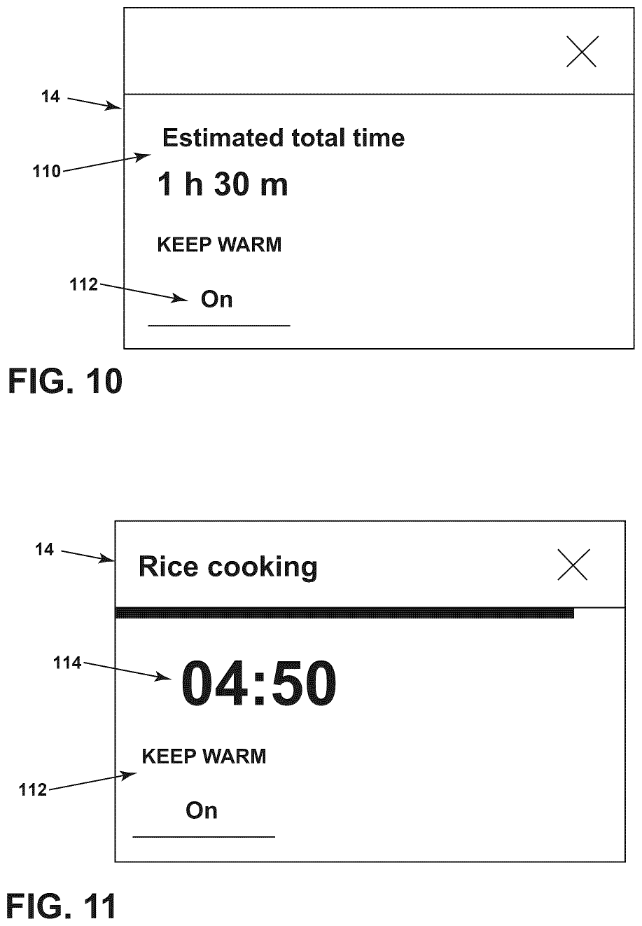

FIG. 10 shows the user interface 14 after a user has selected the start function 104 of FIG. 9. During operation of the custom grain cycle, the heater 36 (FIG. 1) heats the cooking pot 38 (FIG. 1) and the cooking chamber 20 (FIG. 1) to a predetermined temperature for a predetermined amount of time to cook the grain. Such a time can be entered by the user or can be automatically determined by the controller 40 (FIG. 1) and displayed on the user interface 14 as an estimated cooking time 110. Such a determination of cooking time (as well as cooking temperature) can be based upon information stored in the memory 44 (FIG. 1). In non-limiting examples, the controller 40 (FIG. 1) can automatically determine a cooking time based upon one or more of the weight of the grain, the volume of liquid, the grain type, the preparation of the grain 90 (FIG. 7), the liquid type 92 (FIG. 7), or the texture 94 (FIG. 7). A keep warm function 112 can be selected by a user to keep the cooked grain warm after cooking has completed, such as with the heater 36 (FIG. 1) or can be turned off to cease heating of the cooked grain after cooking has completed. FIG. 11 shows the user interface with a time remaining 114, as well as showing the status of the keep warm function 112.

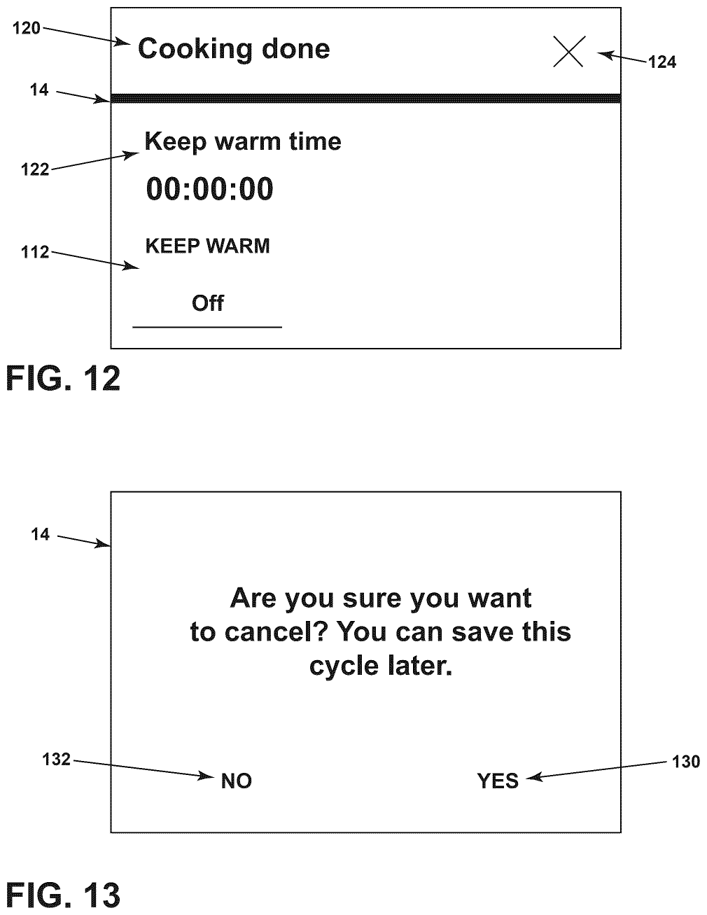

FIG. 12 shows the user interface 14 after cooking and the cycle of operation has completed, showing a cooking done indication 120. A warm timer 122 can be shown or updated by the user to determine a time that the grain cooking appliance 10 (FIG. 1) will keep the cooked grain warm after cooking has completed, as well as including the keep warm function 112 to selectively warm the grain after cooking. The user interface 14 can have a cancel function 124 illustrated as an “X” in the top-right corner of the user interface 14.

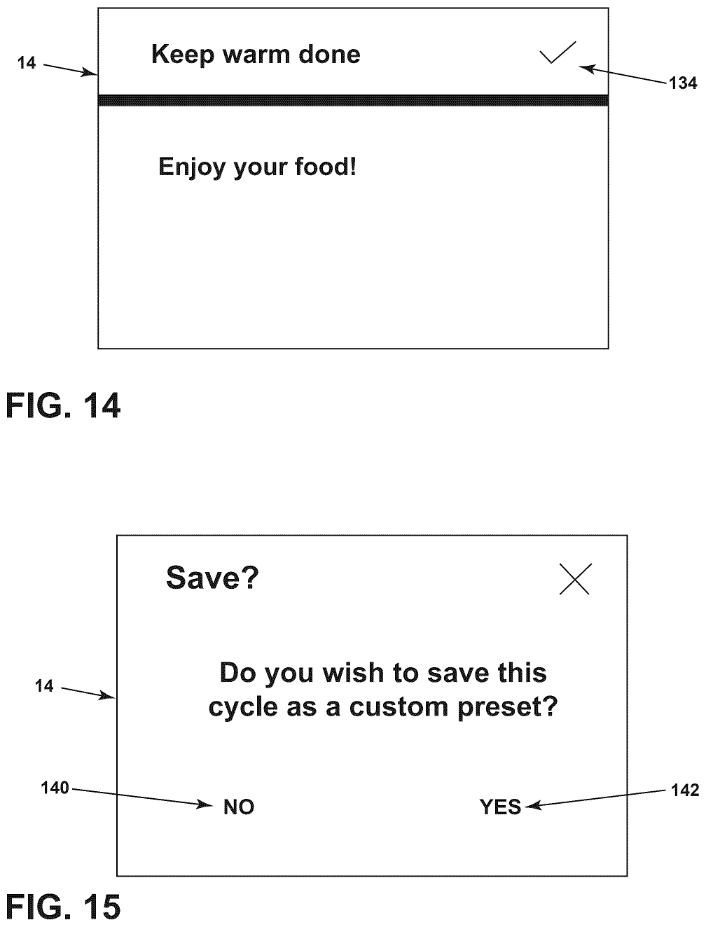

FIG. 13 shows the user interface 14 after a user selects the cancel function 124 of FIG. 12. The user interface 14 prompts a user to confirm canceling of the custom grain cycle with a yes function 130 or to return to FIG. 12 with a no function 132. Alternate to FIG. 13, FIG. 14 shows the user interface 14 after the warm timer 122 (FIG. 12) has reached zero and is no longer warming the cooked grain. A confirmation function 134, illustrated as a checkmark, confirms completion of the custom grain cycle.

FIG. 15 shows the user interface 14 after the user selects the yes function 130 of FIG. 13 or the confirmation function 134 of FIG. 14, prompting the user to save the custom grain cycle. A no function 140 will not save the custom grain cycle, while a yes function 142 will save the custom grain cycle. Selection of the no function 140 can return the user to the main menu 48 (FIG. 2) at the user interface 14, for example. Upon selecting the yes function 142 of FIG. 15, the user can enter a name for the custom grain cycle, such as with a digital keyboard (not shown) provided at the user interface 14.

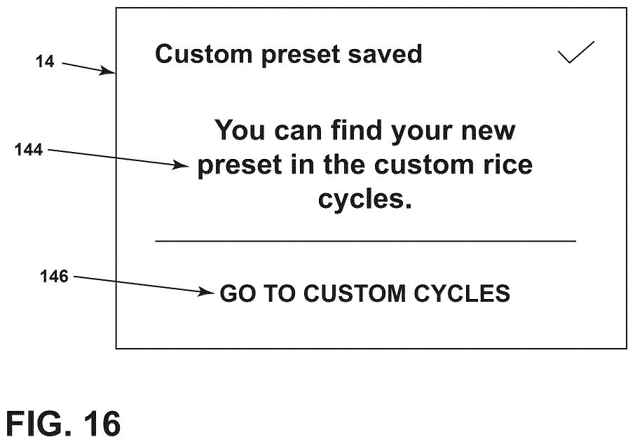

FIG. 16 shows the user interface 14 with a confirmation 144 that the custom grain cycle has been saved. A go to custom cycles function 146 can be selected to take the user to the custom cycles 56 at FIG. 3, for example. While a series of exemplary display screens have been shown it will be understood that any number of screens can be omitted, combined, or otherwise altered.

The controller 40 (FIG. 1) can store or save the custom grain cycle for later use, such as on the memory 44 (FIG. 1). Furthermore, the controller 40 can store or save data or information related to the custom grain cycle, including but not limited to a ratio of grain to liquid. More specifically, the custom grain cycle includes a weight of grain and a volume of liquid utilized in cooking of the grain, which defines the ratio of grain to liquid. When a user selects a saved custom grain cycle, the user will be prompted to add grain to the cooking chamber 20 (FIG. 1), such as that shown at FIGS. 5-6. The weight sensor 30 (FIG. 1) can weigh the grain added to the cooking chamber 20 to determine an exact weight of the grain, while it is contemplated that the user can specify a particular weight, like that as shown at FIG. 6. The controller 40 can then determine the required amount of liquid to be added to the cooking chamber 20 based upon the weight of the grain measured by the weight sensor 30 (or input by the user at the user interface 14) and the ratio of grain to liquid stored on the memory 44 for the custom grain cycle. In this way, a user can vary the amount of grain to be cooked or merely add an unweighed amount of grain, and the grain cooking appliance 10 (FIG. 1) can automatically determine the proper volume of liquid required for the custom grain cycle based upon the amount of grain and the ratio of grain to liquid specific to the custom grain cycle. Furthermore, if the liquid type is water or the same liquid contained in the reservoir 22 (FIG. 1), the grain cooking appliance 10 can automatically provide the proper amount of liquid from the reservoir 22 to the cooking chamber 20 based upon the weighed amount of grain and the ratio of grain to liquid. This permits the user to simply select the custom grain cycle, add grain to the cooking chamber 20, and the grain cooking appliance 10 can automatically add the proper amount of liquid from the reservoir 22 (FIG. 1) based upon the ratio of grain to liquid. This permits the user to vary the amount of grain being cooked or simply add an unmeasured amount of grain to the cooking chamber 20 and achieve a consistent cooking preparation of the grain despite a variable amount of grain being utilized.

Additionally, it is contemplated that a user can update a stored custom grain cycle. For example, a user may select an existing custom grain cycle, which can be listed on the user interface 14 at FIG. 4, for example, and vary the amounts of grain or liquid to vary the grain to liquid ratio, in order to vary the cycle of operation and thus the preparation of the grain. Additionally, it is contemplated that the user can update one or more of the preparation of the grain 90 (FIG. 7), the liquid type 92 (FIG. 7), or the texture 94 (FIG. 7), and the grain cooking appliance 10 can automatically update the custom grain cooking cycle and the grain to liquid ratio based upon the update.

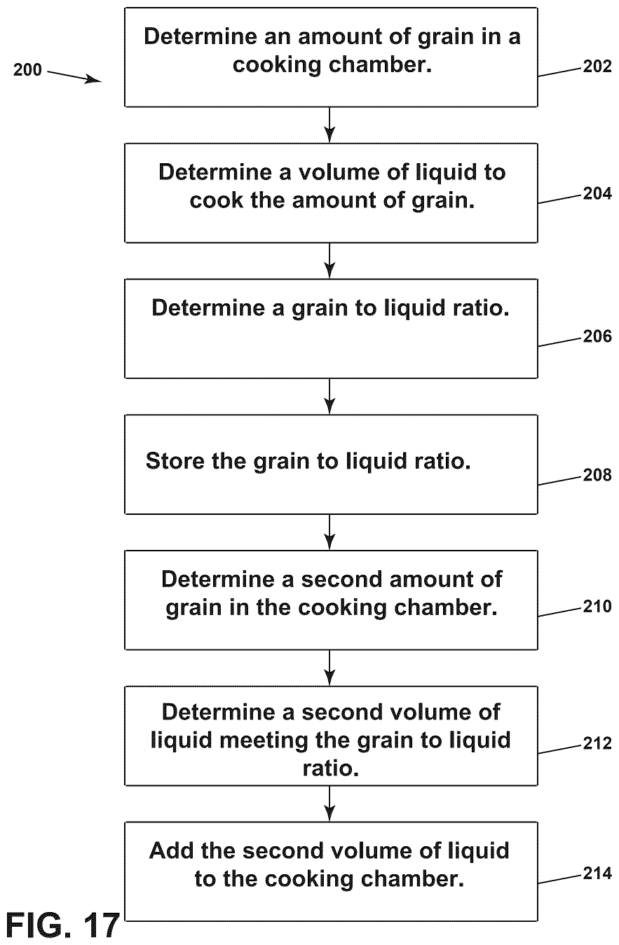

FIG. 17 shows a flow chart depicting a method 200 of operating a grain cooking appliance, like the grain cooking appliance 10 of FIG. 1. At 202, the method 200 includes determining an amount of grain in a cooking chamber. For example, the weight sensor 30 (FIG. 1) can be utilized to determine if a grain has been added to the cooking chamber 20 (FIG. 1.

At 204, the method 200 includes determining a volume of liquid to cook the amount of grain. Such a determination can be input by a user at the user interface 14 (see FIG. 9), for example. It is contemplated that the grain cooking appliance 10 can determine a volume of liquid within the cooking chamber 20 (FIG. 1), such as by weighing the cooking chamber 20 after addition of the volume of liquid and determining a weight of liquid by subtracting the weight of the grain from the total weight of grain and liquid within the cooking chamber 20. For example, a liquid type 92 (see FIG. 7) can be entered by the user, and it is contemplated that the grain cooking appliance 10, by way to the controller 40 (FIG. 1), can determine a volume of liquid based upon the measure weight and a known density of the liquid type 92.

At 206, the method 200 includes determining a grain to liquid ratio. The grain to liquid ratio can be determined as a ratio of the amount or weight of the grain to a volume of liquid and can be determined by the controller 40 (FIG. 1). At 208, the method 200 includes storing the grain to liquid ratio. For example, the grain to liquid ratio can be stored on a memory, such as the memory 44 of FIG. 1.

At 210, the method 200 includes determining a second amount of grain in the cooking chamber. More specifically, after cooking an initial amount of grain within a volume of liquid to define the grain to liquid ratio, another cycle of operation can be performed by the grain cooking appliance 10 to cook the second amount of grain. The user can add an unweighed amount of grain to the cooking chamber 20 as the second amount of grain, and the grain cooking appliance 10 can measure the weight of the amount of grain with the weight sensor 30.

At 212, the method 200 includes determining a second volume of liquid meeting the grain to liquid ratio, based upon the weight of the second amount of grain. The grain cooking appliance 10 can then determine the second volume of liquid to add to the cooking chamber 20 based upon the measured weight of the second amount of grain and the grain to liquid ratio, such as with the controller 40 (FIG. 1). At 214, the second volume of liquid can be added by the user to the cooking chamber 20 or can be added by the grain cooking appliance 10 from the reservoir 22 via the conduit 32 (see FIG. 1).

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Moreover, while “a set of” or “a plurality of” various elements have been described, it will be understood that “a set” or “a plurality” can include any number of the respective elements, including only one element. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects of the disclosure are provided by the following clauses:

A grain cooking appliance comprising: a cooking chamber; a liquid dispenser fluidly coupled to the cooking chamber; a controller operably coupled to the liquid dispenser, the controller configured to: store a grain to liquid ratio; determine a volume of a liquid that meets the grain to liquid ratio based an amount of grain in the cooking chamber; and dispense the volume of the liquid to the cooking chamber from the liquid dispenser.

The grain cooking appliance of any preceding clause, further comprising a user interface operably coupled to the controller and configured to receive user input relating to the grain to liquid ratio.

The grain cooking appliance of any preceding clause, wherein the controller is configured to receive, from the user interface, a preparation of the grain including at least one of a washed preparation, a dry preparation, or a wet preparation.

The grain cooking appliance of any preceding clause, wherein the controller is configured to receive from the user interface at least one of a type of the grain or a texture of the grain.

The grain cooking appliance of any preceding clause, wherein the controller is configured to receive at least the texture of the grain, and wherein the texture of the grain is one of regular, sticky, soft, firm, or al dente.

The grain cooking appliance of any preceding clause, wherein the controller is further configured to receive a type of liquid at the user interface.

The grain cooking appliance of any preceding clause, wherein the type of liquid is one of a water, a broth, or a stock.

The grain cooking appliance of any preceding clause, wherein the controller is further configured to determine the amount of grain in the cooking chamber.

The grain cooking appliance of any preceding clause, further comprising a weight sensor coupled to the cooking chamber for weighing the cooking chamber to determine the amount of grain.

The grain cooking appliance of any preceding clause, wherein the cooking chamber can be moved to a lifted position from a received position and wherein a return to the received position from the lifted position initiates weighing of the cooking chamber to determine the amount of grain.

The grain cooking appliance of any preceding clause, wherein the controller is configured to receive the amount of grain in the cooking chamber as an input from a user input.

The grain cooking appliance of any preceding clause, wherein the controller is further configured to complete a cycle of operation to cook the amount of grain in the volume of liquid meeting the grain to liquid ratio.

The grain cooking appliance of any preceding clause, wherein the cycle of operation is based upon the grain to liquid ratio and the amount of grain.

A grain cooking appliance comprising: a cooking chamber; a controller configured to: determine an amount of grain within the cooking chamber; determine a volume of liquid within the cooking chamber; determine a grain to liquid ratio based upon the amount of grain and the volume of liquid within the cooking chamber; and store the grain to liquid ratio.

The grain cooking appliance of any preceding clause, further comprising a user interface.

The grain cooking appliance of any preceding clause, wherein the controller is configured to receive at least one of the amount of grain or the volume of liquid input at the user interface.

The grain cooking appliance of any preceding clause, wherein the controller is further configured to operate a cycle of operation to cook a second amount of grain in the cooking chamber based upon the stored grain to liquid ratio.

The grain cooking appliance of any preceding clause, further comprising a weight sensor operably coupled to the cooking chamber, wherein the controller is further configured to determine a weight of the second amount of grain in the cooking chamber with the weight sensor, and wherein the controller is further configured to determine a second volume of liquid based upon the weight of the second amount of grain and the grain to liquid ratio.

The grain cooking appliance of any preceding clause, further comprising a liquid dispenser operably coupled to the controller and fluidly coupled to the cooking chamber, and wherein the controller is further configured to dispense the second volume of liquid to the cooking chamber from the liquid dispenser.

The grain cooking appliance of any preceding clause, further comprising a weight sensor operably coupled to the cooking chamber, wherein the controller is configured to determine the amount of grain by weighing the cooking chamber with the weight sensor.

A method of cooking a grain with a grain cooking appliance having a cooking chamber and a liquid dispenser fluidly coupled to the cooling chamber, the method comprising: storing a grain to liquid ratio; determining a volume of a liquid that meets the grain to liquid ratio based an amount of grain in the cooking chamber; and dispensing the volume of the liquid to the cooking chamber from the liquid dispenser.

The method of any preceding clause, further comprising determining a weight of the amount of grain in the cooking chamber.

The method of any preceding clause, wherein determining the weight of the amount of grain includes weighing the cooking chamber with a weight sensor.

The method of any preceding clause, further comprising lifting the cooking chamber from the grain appliance to trigger weighing of the grain.

The method of any preceding clause, wherein returning the cooking chamber to the grain appliance after lifting the cooking chamber triggers weighing of the grain.

The method of any preceding clause, further comprising inputting, at a user interface, a preparation of the grain.

The method of any preceding clause, wherein the preparation is one of a washed preparation, a dry preparation, or a wet preparation.

The method of any preceding clause, further comprising updating the volume of liquid required to match the custom grain cooking ratio based upon the preparation of the grain.

The method of any preceding clause, further comprising inputting a texture of the grain.

The method of any preceding clause, wherein the texture of the grain is one of regular, sticky, soft, firm, or al dente.

The method of any preceding clause, further comprising updating the volume of liquid required to match the custom grain cooking ratio based upon the texture of the grain.

A method of generating a custom grain cooking ratio for a grain cooking appliance, the method comprising: determining an amount of grain within the cooking chamber; determining a volume of liquid within the cooking chamber; determining a grain to liquid ratio based upon the amount of grain and the volume of liquid within the cooking chamber; and

storing the grain to liquid ratio.

The method of any preceding clause, wherein determining the volume of liquid within the cooking chamber further comprises entering a volume for the liquid on a user interface for the grain cooking appliance, and wherein the grain cooking appliance supplies the entered volume of fluid to the cooking chamber from a fluid reservoir.

The method of any preceding clause, wherein determining the volume of liquid added to the cooking chamber further comprises inputting the volume of liquid added to the cooking chamber at a user interface on the grain cooking appliance.

The method of any preceding clause, wherein the type of liquid is one of a water, a broth, or a stock.

The method of any preceding clause, further comprising lifting the cooking chamber from the grain appliance to trigger weighing of the grain.

The method of any preceding clause, wherein returning the cooking chamber to the grain appliance after lifting the cooking chamber triggers weighing of the grain.

The method of any preceding clause, further comprising inputting, at a user interface, a preparation of the grain.

The method of any preceding clause, wherein the preparation is one of a washed preparation, a dry preparation, or a wet preparation.

The method of any preceding clause, further comprising inputting a texture of the grain.

The method of any preceding clause, wherein the texture of the grain is one of regular, sticky, soft, firm, or al dente.

The method of any preceding clause, further comprising cooking the grain with the grain cooking appliance.

The method of any preceding clause, further comprising cooking a second grain based upon the grain cooking ratio.

The method of any preceding clause, further comprising weighing the second grain to determine a second weight; and automatically adding a second volume of liquid from a fluid reservoir to the cooking chamber such that a ratio of the second weight to the second volume is the same as the stored custom grain ratio.

What is claimed is:

1. A grain cooking appliance comprising:
a cooking chamber;
a liquid dispenser fluidly coupled to the cooking chamber;
a controller operably coupled to the liquid dispenser, the controller configured to:
store a grain to liquid ratio;
determine a volume of a liquid that meets the grain to liquid ratio based upon an amount of grain in the cooking chamber; and
dispense the volume of the liquid to the cooking chamber from the liquid dispenser.

2. The grain cooking appliance of claim 1, further comprising a user interface operably coupled to the controller and configured to receive user input relating to the grain to liquid ratio.

3. The grain cooking appliance of claim 2, wherein the controller is configured to receive, from the user interface, a preparation of the grain including at least one of a washed preparation, a dry preparation, or a wet preparation.

4. The grain cooking appliance of claim 2, wherein the controller is configured to receive from the user interface at least one of a type of the grain or a texture of the grain.

5. The grain cooking appliance of claim 4, wherein the controller is configured to receive at least the texture of the grain, and wherein the texture of the grain is one of regular, sticky, soft, firm, or al dente.

6. The grain cooking appliance of claim 2, wherein the controller is further configured to receive a type of liquid at the user interface.

7. The grain cooking appliance of claim 6, wherein the type of liquid is one of a water, a broth, or a stock.

8. The grain cooking appliance of claim 1, wherein the controller is further configured to determine the amount of grain in the cooking chamber.

9. The grain cooking appliance of claim 8, further comprising a weight sensor coupled to the cooking chamber for weighing the cooking chamber to determine the amount of grain.

10. The grain cooking appliance of claim 9, wherein the cooking chamber can be moved to a lifted position from a received position and wherein a return to the received position from the lifted position initiates weighing of the cooking chamber to determine the amount of grain.

11. The grain cooking appliance of claim 8, wherein the controller is configured to receive the amount of grain in the cooking chamber as an input from a user input.

12. The grain cooking appliance of claim 1, wherein the controller is further configured to complete a cycle of operation to cook the amount of grain in the volume of liquid meeting the grain to liquid ratio.

13. The grain cooking appliance of claim 12, wherein the cycle of operation is based upon the grain to liquid ratio and the amount of grain.

14. A grain cooking appliance comprising:
a cooking chamber;
a controller configured to:
determine an amount of grain within the cooking chamber;
determine a volume of liquid within the cooking chamber;
determine a grain to liquid ratio based upon the amount of grain and the volume of liquid within the cooking chamber; and
store the grain to liquid ratio.

15. The grain cooking appliance of claim 14, further comprising a user interface.

16. The grain cooking appliance of claim 15, wherein the controller is configured to receive at least one of the amount of grain or the volume of liquid input at the user interface.

17. The grain cooking appliance of claim 14, wherein the controller is further configured to operate a cycle of operation to cook a second amount of grain in the cooking chamber based upon the stored grain to liquid ratio.

18. The grain cooking appliance of claim 17, further comprising a weight sensor operably coupled to the cooking chamber, wherein the controller is further configured to determine a weight of the second amount of grain in the cooking chamber with the weight sensor, and wherein the controller is further configured to determine a second volume of liquid based upon the weight of the second amount of grain and the grain to liquid ratio.

19. The grain cooking appliance of claim 18, further comprising a liquid dispenser operably coupled to the controller and fluidly coupled to the cooking chamber, and wherein the controller is further configured to dispense the second volume of liquid to the cooking chamber from the liquid dispenser.

20. The grain cooking appliance of claim 14, further comprising a weight sensor operably coupled to the cooking chamber, wherein the controller is configured to determine the amount of grain by weighing the cooking chamber with the weight sensor.
